(19) United States
(12) Patent Application Publication
(10) Pub. No.: US 2024/0040994 A1
(43) Pub. Date: Feb. 8, 2024

(54) PET FEEDING MAT

(71) Applicant: Chad Perry, Wichita Falls, TX (US)

(72) Inventor: Chad Perry, Wichita Falls, TX (US)

(21) Appl. No.: 18/379,179

(22) Filed: Oct. 12, 2023

(51) Int. Cl. A01K 5/01

(52) U.S. Cl. CPC A01K 5/0142; A01K 5/0135

(57) ABSTRACT

The present invention relates to a water-proof and portable pet feeding mat that is adapted to have a non-slip bottom surface, a textured top surface to prevent flipping over of the food container placed thereon, a pair of handles that provides gripping and holding strength while carrying the mat to different locations, and a water moat to prevent ants and other crawling insects from gaining access to the food kept thereon. According to main embodiment of the present invention, the pet feeding mat includes a semi rigid base, a bed, and a water moat. The semi rigid base is adapted to have side walls, the pair of handles, and bottom non-slip surface. The bed includes a top surface, and raised patterns. The water moat is formed between the side walls and the bed.

### TECHNICAL FIELD OF INVENTION

The present invention relates to a pet feeding device. More particularly, the present invention relates to a water-proof, portable, and washable pet feeding mat with a non-slip bottom surface, a textured top surface to prevent flipping over of the food bowl therefrom, a pair of handles to help in carrying the mat to a new location, and a water moat to prevent ants and other crawling insects from gaining access to the food kept on top of the mat.

### BACKGROUND

With the continuous improvement of living standards, it is becoming more and more common to keep pets in the family Among pets, dogs and cats are the most common. Presently, food containers are placed either directly on the floor or on some simple plastic tray cum mats for feeding pet animals. The plastic tray or mats are made of hard material, their friction with the smooth ground is small, so the grip is poor thus the containers or mats kept over the such plastic mats will slide when a dog or cat is eating.

Some of the existing feeding mats are made with fabric, and are often stuffed with soft material and are typically not water-resistant. Therefore, they tend to acquire odor and are subject to damage or destruction, whether by the pet animal, moisture, or overall environmental exposure. The washing of such fabric mats is cumbersome. when a pet eats food from the food-containing container kept on such existing feeding mats, the food container is usually overturned, or the food container gets displaced from original position while eating, thereby causing the food to spill and usually such feeding mats are not easy to clean. Therefore, there is a need for a mat that may be easy to use and wash.

The pet food containers or mats attract ants and other crawling insects that can transmit disease or can cause other harm to both the pet animal and the pet owner. Accordingly, it would be desirable to prevent the insects which are able to contact food in a mat and food container. Further, it is noted that rubber or elastic food mats are difficult to carry from one place to another.

A variety of domestic pet food mats have been conceived and exist in the prior art, for example but not limited to:

U.S. Pat. No. 7,040,252 discloses a pet feeding device for holding a commercially available disposable paper plate. The device comprises a tray base with four molded integral hooks. The paper plate slides in place under three of the four hooks and snapped in place under the fourth hook to secure it in place. The tray base prevents food displaced from the plate by the feeding animal from falling on the floor. The paper plate is disposed off after use. The tray base is made of plastic or similar material that is easily washable by hand or in a dishwasher.

U.S. Patent Publication No. 2013/0305996 discloses a tray for presenting food to a pet or animal. The tray includes a top side, an underside, and a peripheral side extending between the top side and the underside. The top side is a series of interconnected grooves resembling troughs that traverse the tray.

U.S. Pat. No. 7,178,798 discloses a cutting board comprising a top surface and a bottom surface. The top surface is bounded by a raised edge curvilinearly extending into a channel encompassing a planar work surface. At one end, fluid and food in the channel pools into a reservoir having a spillway with a lip extending sconce-like and coplanar with the raised edge forming a spout. The bottom side is notched to serve as a handhold opposing the spout. The work surface recess that serves to decrease mass is ribbed by a lattice of intersecting walls providing a lightweight product while substantially increasing the work surface load capacity.

U.S. Pat. No. 4,357,905 provides an insect-repelling pet food dish wherein double bowled pet dish is conceived with the water from a water bowl on one side of the dish is channeled to the solid food side in which is suspended a solid food bowl. In short, the solid food bowl is surrounded by a moat of water sustained by water from the water side of the pet dish.

Although each of the above prior art pet food mats function as designed to varying extent, each of the prior art is burdened with inherent limitations. Few of the above cited patents utilize a water moat and suspended food receptacles there above with reverse inclined walls to inhibit the travel of crawling insects, however, these mats are fairly complex in design and difficult to assemble and mold manufacture in mass. On the other hand, a few of the existing solutions are relatively simple in structure and design and relatively easy to mass mold but fails to provide strong handles and lightweight mats.

In the light of foregoing, there is a need for a portable, lightweight, waterproof, and non-slip pet feeding designed to prevent ants and other crawling insects from gaining access to the food kept thereon.

### SUMMARY

The present invention provides a pet feeding mat that overcomes problems prevalent in the prior art by providing a simple and lightweight structure.

It is a primary object of the invention to provide a pet feeding mat that is portable and easy to handle and move to new locations due to strong handles provided thereof.

Another object of the invention to provide a pet feeding mat that prevents sliding of the food container when the pet animal such as a dog or cat is eating food therefrom.

Another object of the invention to provide a pet feeding mat made from a non-toxic material, and is durable, scratch and bite resistant, washable, and available in a variety of colors, sizes, and shapes.

It is an object of the invention to provide a pet feeding mat that prevents ants and other crawling insects from reaching food held in the container or kept in the mat without using any toxic materials.

Another object of the invention is to provide a food-feeding mat that is made out of food-grade material that prevents spoilage of the food, and reduces bacteria growth observed within a short period of time under the food placed on the mat.

It is yet another object of the present invention is to provide a pet feeding mat that can be manufactured easily, smoothly, at low cost, and with high productivity.

According to the main embodiment of the present invention, the pet feeding mat includes a semi-rigid base, a bed, and a water moat. The semi-rigid base is adapted to have side walls, a pair of handles, and a bottom non-slip surface. The bed includes a top surface, and raised patterns. The water moat is formed between the side walls and the bed. According to one aspect of the present invention, the mat is manufactured quadrilateral in shape selected from a square, a rectangle, a rhombus, a kite, a trapezoid, and a parallelogram. As per another aspect of the present invention, the mat is a circular or semicircular shape in shape or is a combination of circular and rectangular shapes.

Various objects, features, aspects, and advantages of the present invention will become more apparent from the following detailed description of the embodiments of the invention, along with the accompanying drawings in which like numerals represent like components.

### BRIEF DESCRIPTION OF DRAWINGS

So that the manner in which the above-recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments. These and other features, benefits, and advantages of the present invention will become apparent by reference to the following text figure, with like reference numbers referring to like structures across the views, wherein:

FIGS. 1A and 1B show front and back perspective views of a pet feeding mat in accordance with an exemplary embodiment of the present invention;

FIG. 2 shows a front view of the pet feeding mat of FIG. 1;

FIG. 3 shows a cross-sectional view of FIG. 1 taken along A-A;

FIGS. 4 and 5 show sectional views of FIG. 2;

FIG. 6 shows the pet feeding mat of FIG. 2 arranged on a floor;

FIG. 7 shows the pet feeding mat of FIG. 2 held by a pet owner for locating the mat at a different location;

FIG. 8 shows a view of the water moat of FIG. 2 filled with water;

FIG. 9 shows a view of a side wall of the pet feeding mat of FIG. 2;

FIG. 10 shows the use case of the pet feeding mat of FIG. 2 with a pet;

FIGS. 11A and 11B show a front and rear perspective views of a pet feeding mat in accordance with another embodiment of the present invention respectively;

### DETAILED DESCRIPTION

Some embodiments, illustrating its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, several materials are identified as suitable for various facets of the implementations. These materials are to be treated as exemplary and are not intended to limit the scope of the invention.

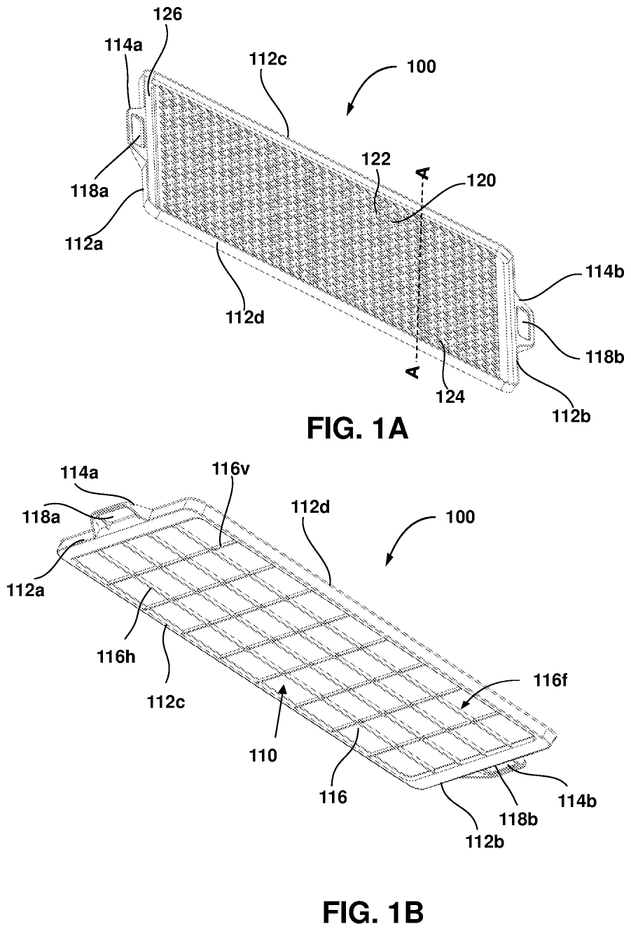

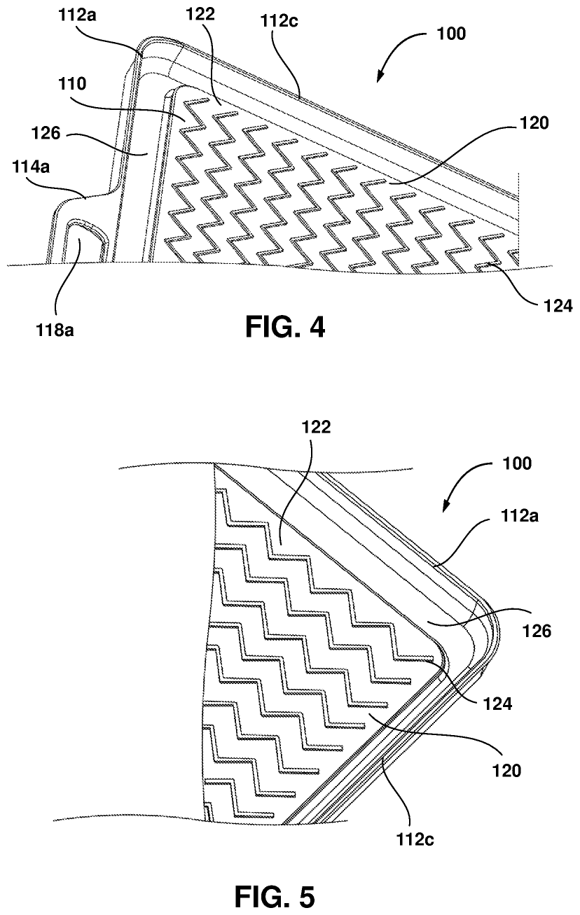

The various features and embodiments of the present invention will now be described in conjunction with the accompanying figures, namely FIGS. 1A-11B, which should be regarded as merely illustrative without restricting the scope and ambit of the present invention.

The present invention provides a waterproof, portable, and washable pet feeding mat with a non-slip bottom surface, a textured top surface to prevent flipping over of the food bowl therefrom, a pair of handles to help in carrying the mat to a new location, and a water moat to prevent ants and other crawling insects from gaining access to the food kept on top of the mat.

From herein afterward, the mat is referred to as a mat 100.

Referring now to FIGS. 1A and 1B, the mat 100 includes a semi-rigid base 110, a bed 120, and a water moat 126. The mat 100 is made from a material selected from a semi-rigid material. The semi-rigid material is selected from silicon, rubber, polymer, elastomeric compound, and thermoplastic compound. The silicon is preferred food-grade material. The mat 100 is quadrilateral in shape. The most preferred quadrilateral shapes are a square, a rectangle, a rhombus, a kite, a trapezoid, and a parallelogram.

The semi-rigid base 110 is adapted to have side walls 112a, 112b, 112c, 112d, a pair of handles 114a, 114b, and a bottom non-slip surface 116. The side walls 112a, 112b, 112c, 112d are extended from the base 110 in a vertical direction. The side walls 112a, 112b, 112c, 112d has a pair of short walls 112a, 112b, and a pair of long walls 112c, 112d. Referring now to FIG. 9, the side walls 112a, 112b, 112c, 112d are provided with an edge portion 113 extended in a horizontal direction. Each of the short walls 112a and 112b includes a handle from the pair of handles 114a and 114b. The handles 114a, 114b extends perpendicularly from the short walls 112a and 112b. Each handle 114a or 114b includes a cut-out section 118a or 118b respectively. The cut-out sections 118a or 118b are provided for inserting fingers while holding and carrying the mat 100 as best seen in FIG. 7.

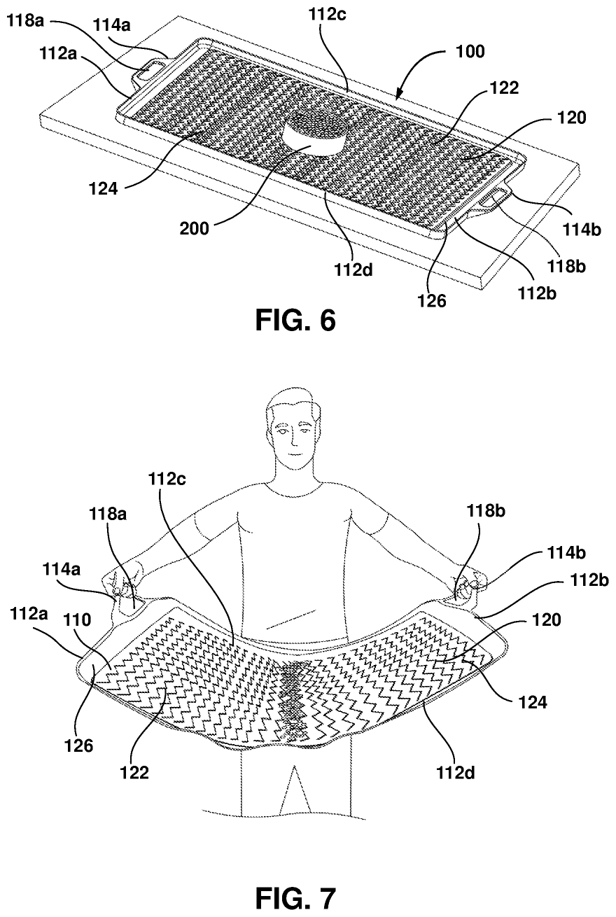

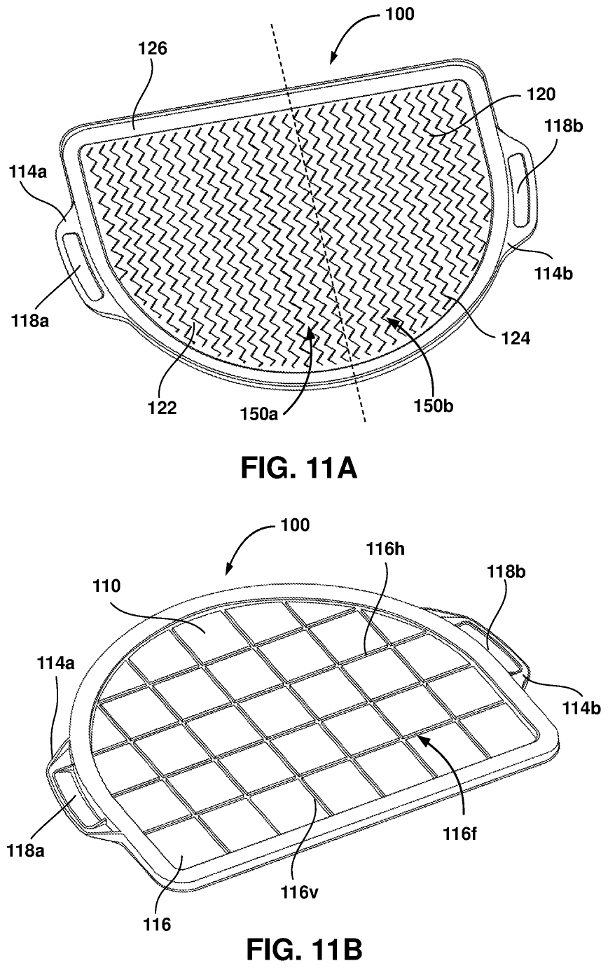

The bottom non-slip surface 116 includes a friction mesh 116f. The friction mesh 116f includes vertical and horizontal members 116v, 116h (FIGS. 1B and 11B). The friction mesh 116f resists the movements of the mat 100 when the mat 100 is placed on the floor as seen in FIG. 6. The friction mesh 116f further provides strength to the mat 100.

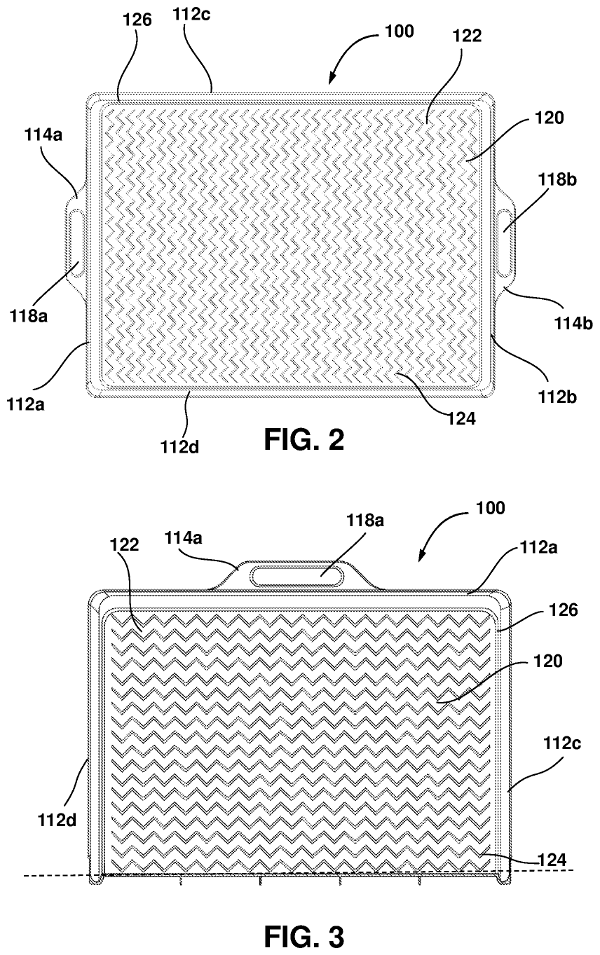

The bed 120 has a top surface 122 and raised patterns 124 (FIGS. 2, 3, 4, and 5). According to the main embodiment of the present invention, the side walls 112a, 112b, 112c, 112d and the top surface 122 are provided with the same height. In one more exemplary non limiting implementation of the present invention, the side walls 112a, 112b, 112c, 112d and the top surface 122 are provided with different heights. The raised pattern provides strength to the mat 100 while carrying. The friction mesh 116f and the raised pattern 124 provide a shock absorbing effect when the pet or pet owner passes therefrom. According to the main embodiment of the present invention, the raised patterns 124 are uniform in size and shape. In one more exemplary non-limiting implementation of the present invention, the raised patterns 124 are non-uniform in size and shape. The raised pattern 124 may be a zigzag pattern, sinusoidal pattern, or any other suitable pattern.

According to the main embodiment of the present invention, the bed 120 and the base 110 are molded as a single piece. In one more exemplary non-limiting implementation of the present invention, the bed 120 and the base 110 are manufactured separately and then attached together. The bed 120 is attached to the base 110 using a sticking material for example. The sticking material may include glue, adhesive, 3M tape, etc.

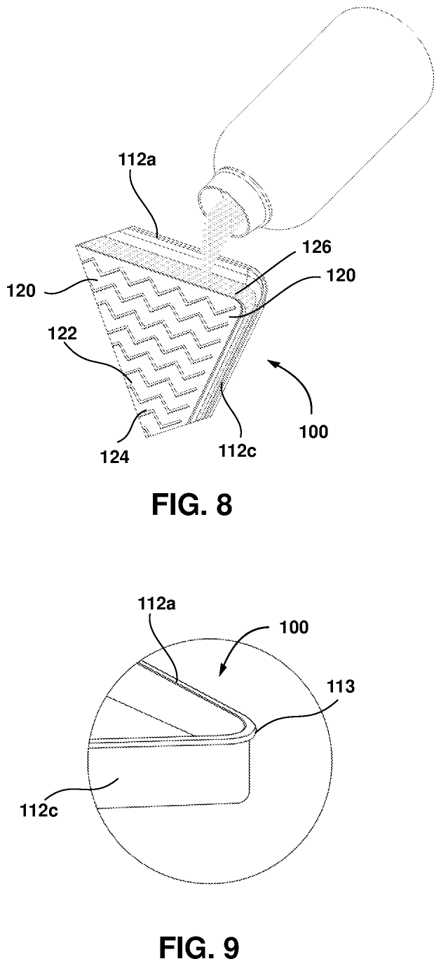

The water moat 126 is formed between the side walls 112a, 112b, 112c, 112d and the bed 120. According to the main embodiment of the present invention, a width of the water moat 126 along opposite side walls 112a and 112b or 112c and 112d may be identical and/or smaller compared to the other two side walls 112c and 112d; or 112a and 112b. According to another embodiment of the present invention, the width of the water moat 126 along opposite side walls 112a and 112b or 112c and 112d is different compared to the other two side walls 112c and 112d or 112a and 112b. Referring now to FIG. 8, the water moat 126 is filled with water. The water moat 126 when filled with fluid such as water prevents ants and other crawling insects from reaching food held in the container 200 (placed on the mat) or food kept directly on the mat without using any toxic materials.

Referring now to FIGS. 11A and 11B, another embodiment of the mat 100 is disclosed. The mat 100 is a circular or semicircular in shape or is a combination of circular and rectangular shape or a combination of semi-circular and rectangular. The mat 100 has a first-half portion 150a and a second-half portion 150b. Each of the first half portion 150a and the second half of portion 150b is provided with the pair of handles 114a, and 114b respectively. The features and functions of the mat 100 of FIGS. 11A and 11B is identical to the mat 100 of FIG. 1.

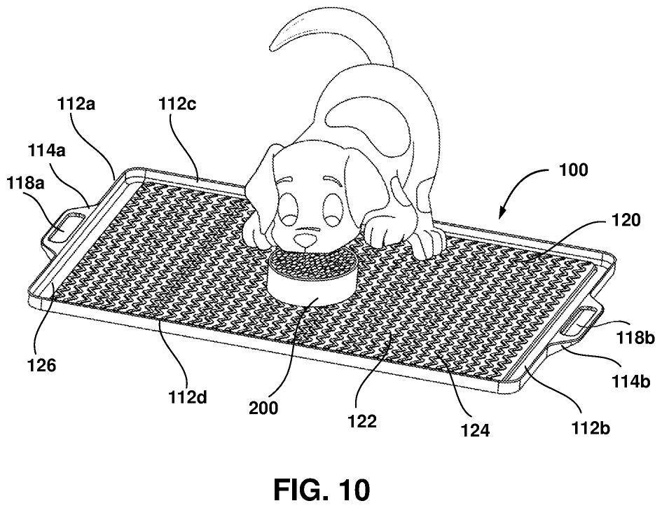

In a given example as shown in FIG. 10, the user needs to place the mat 100 on the floor such that the friction mesh 116f resists the movements of the mat 100 on the floor. The food container 200 is placed on the mat 100 such that container movements are partially restricted by the raised patterns 124. Further, the water moat 126 is filled with water. Once the pet completes eating, the user can hold the mat 100 by inserting fingers in the cut-out sections 118a and 118b of the handles 114a and 114b for carrying the mat 100 to a washing area (such as in the basin under the tape water). The user can wash the mat 100 using water easily.

It should be understood according to the preceding description of the present invention that the same is susceptible to changes, modifications and adaptations, and that the said changes, modifications and adaptations fall within scope of the appended claims

What is claimed is:

1. A pet feeding mat (100), comprising:
a semi rigid base (110) comprising a plurality of side walls (112a, 112b, 112c, 112d),
a pair of handles (114a, 114b), and bottom non-slip surface (116); and
a bed (120) comprising a top surface (122), and a plurality of raised patterns (124); and
a water moat (126) formed between the plurality of side walls (112a, 112b, 112c, 112d) and the bed (120).

2. The pet feeding mat (100) of claim 1, wherein the mat (100) is waterproof.

3. The pet feeding mat (100) of claim 1, wherein the mat (100) is made from material selected from a group consisting of silicon, rubber, polymer, elastomeric compound, thermoplastic compound.

4. The pet feeding mat (100) of claim 1, wherein the mat (100) is quadrilateral in shape selected from a square, a rectangle, a rhombus, a kite, a trapezoid, a parallelogram.

5. The pet feeding mat (100) of claim 1, wherein the plurality of side walls (112a, 112b, 112c, 112d) comprises a pair of short walls (112a, 112b), and a pair of long walls (112c, 112d).

6. The pet feeding mat (100) of claim 5, wherein each of the short walls (112a and 112b) comprises a handle from the pair of handles (114a and 114b) perpendicularly extending from the short walls (112a and 112b).

7. The pet feeding mat (100) of claim 1, wherein each of the pair of handles (114a and 114b) comprise a cut-out section (118a or 118b).

8. The pet feeding mat (100) of claim 1, wherein the bottom non-slip surface (116) comprises a friction mesh (1161).

9. The pet feeding mat (100) of claim 8, wherein the friction mesh (116f) comprises a plurality of vertical and horizontal members (116v, 116h).

10. The pet feeding mat (100) of claim 1, wherein the raised patterns (124) are uniform in size and shape.

11. The pet feeding mat (100) of claim 1, wherein the raised patterns (124) are non-uniform in size and shape.

12. The pet feeding mat (100) of claim 1, wherein the plurality of side walls (112a, 112b, 112c, 112d) and the top surface (122) comprises the same height.

13. The pet feeding mat (100) of claim 1, wherein the plurality of side walls (112a, 112b, 112c, 112d) and the top surface (122) comprises different height.

14. The pet feeding mat (100) of claim 1, wherein the mat (100) is a circular or semicircular shape in shape or is a combination of circular and rectangular shape.

15. The pet feeding mat (100) of claim 14, wherein the mat (100) has a first half portion (150a) and a second half portion (150b).

16. The pet feeding mat (100) of claim 15, wherein each of the first half portion (150a) and the second half portion (150b) are provided with the pair of handles (114a, 114b) respectively.

17. The pet feeding mat (100) of claim 1, wherein the bed (120) and the base (110) are molded as a single piece.

18. The pet feeding mat (100) of claim 1, wherein the bed (120) and the base (110) are manufactured separately.

19. The mat (100) of claim 18, wherein the bed (120) is attached to the base (110) using a sticking material.

20. The mat (100) of claim 1, wherein the water moat (126) along opposite side walls (112a and 112b or 112c and 112d) is identical in width and/or smaller in width compared to other two side walls (112c and 112d or 112a and 112b).
